(19) United States
(12) Patent Application Publication
(10) Pub. No.: US 2022/0009404 A1
(43) Pub. Date: Jan. 13, 2022

(54) LAMP CONTROL DEVICE FOR VEHICLE

(71) Applicant: KOITO MANUFACTURING CO., LTD., TOKYO (JP)

(72) Inventors: Toshihiko KUREBAYASHI, Shimizu-ku (JP); Takayuki KATO, Shimizu-ku (JP); Takayoshi MOCHIZUKI, Shimizu-ku (JP)

(73) Assignee: KOITO MANUFACTURING CO., LTD., TOKYO (JP)

(21) Appl. No.: 17/368,942

(22) Filed: Jul. 7, 2021

(30) Foreign Application Priority Data
Jul. 10, 2020 (JP) 2020-118840

(51) Int. Cl. B60Q 1/04; F21S 43/14; B60Q 1/00; H05B 47/155

(52) U.S. Cl. CPC B60Q 1/04; F21S 43/14; B60Q 2300/05; H05B 47/155; B60Q 1/0023

(57) ABSTRACT

A lamp control device includes: at least two lamps; a lamp ECU provided in each of the at least two lamps and configured to perform a lamp control on the each of the at least two lamps; and a vehicle ECU configured to communicate a control signal to the lamp ECU. The vehicle ECU is connected to the lamp ECU via a first high-speed communications line. The lamp ECU is configured to independently perform a lamp control by communication through the first high-speed communications line.

### CROSS-REFERENCE TO RELATED APPLICATION

This application claims priority to Japanese Patent Application No. 2020-118840 filed on Jul. 10, 2020, incorporated herein by reference in its entirety.

### BACKGROUND

### 1. Technical Field

The present disclosure relates to a lamp control device for performing various lamp controls including light distribution of a plurality of lamps disposed in a vehicle such as an automobile.

### 2. Description of Related Art

A vehicle, particularly, an automobile is provided with a dedicated electronic control unit (hereinafter referred to as a lamp ECU) in order to perform various lamp controls such as turning on and off of head lamps, light distribution, and a lamp irradiation direction (aiming). The lamp ECU is connected to a main electronic control unit (hereinafter referred to as a vehicle ECU) disposed in the automobile and controls each of the head lamps based on a control signal output from the vehicle ECU.

As a lamp control device including such a lamp ECU, Japanese Unexamined Patent Application Publication No. 2013-6580 (JP 2013-6580 A) and Japanese Unexamined Patent Application Publication No. 2014-19347 (JP 2014-19347 A) propose a lamp control device in which a lamp ECU disposed in a first head lamp out of right and left head lamps provided in an automobile is configured as a master lamp ECU, and a lamp ECU disposed in a second head lamp out of the right and left head lamps is configured as a slave lamp ECU. In the lamp control device, the master lamp ECU performs a main process based on a control signal from a vehicle ECU so that the master lamp ECU controls the first head lamp on its own side in accordance with the control signal thus obtained. Further, at the same time as above, the control signal thus obtained is transmitted to the slave lamp ECU so that the slave lamp ECU controls the second head lamp on its own side in accordance with the control signal thus transmitted.

When the control signal is transmitted by performing communication between the master lamp ECU provided in the first head lamp and the slave lamp ECU provided in the second head lamp as such, it is possible to perform a lamp control on the right and left head lamps in an integrated manner based on the same control signal. Further, when the lamp ECU on the second head lamp side is constituted by the slave lamp ECU that is obtained at a lower cost than the master lamp ECU, the lamp control device can be manufactured at a low cost.

Such a lamp control device including the master lamp ECU and the slave lamp ECU is configured such that the vehicle ECU is connected to the master lamp ECU via a controller area network (CAN) line that has a high communication speed, and the master lamp ECU and the slave lamp ECU are connected to each other via a local interconnect network (LIN) line that has a communication speed lower than that of the CAN line. That is, when the control signal from the vehicle ECU is transmitted to the master lamp ECU by use of the high-speed CAN line, a highly responsive lamp control signal can be formed for the master lamp ECU. In the meantime, speeds required for controls on a lamp unit and a leveling actuator subjected to lamp controls are not so high. Accordingly, the LIN line that can be configured at a low cost is used for those controls.

### SUMMARY

In the meantime, an adaptive driving beam (ADB) light distribution control is employed as one mode of a light distribution control on a head lamp. In recent years, in order to achieve a highly accurate ADB light distribution control, it has been requested to section an ADB light distribution region into a quite large number of micro-irradiation regions and to control light emission and extinction of each of the micro-irradiation regions at high speed. However, in a configuration where a lamp control by the lamp ECU is performed by LIN communication using the LIN line, it is difficult to deal with such a high-speed control, and therefore, it is difficult to achieve an increase in accuracy of the ADB light distribution control. Particularly, in a configuration where the master side is connected to the slave side via the LIN line, it is difficult to achieve an increase in speed and accuracy of the lamp control on the slave side.

Further, in a configuration where the vehicle ECU is connected to only the lamp ECU on the master side via the CAN line, when an abnormality occurs on the master side and the lamp control cannot be performed on the master side, the lamp control on the slave side also becomes difficult. On this account, it cannot but take measures to stop both of the lamp controls on the master side and the slave side, and thus, a fail-safe problem occurs. Even if the lamp ECU on the slave side is configured to perform control independently, the control signal from the vehicle ECU is transmitted to the slave side through the CAN line and then through the LIN line. As a result, it is difficult to achieve a high-speed lamp control.

The present disclosure provides a lamp control device for a vehicle, and the lamp control device can secure a fail-safe for a plurality of lamps and achieve a high-speed control.

A lamp control device for a vehicle according to an aspect of the present disclosure includes at least two lamps, a lamp electronic control unit, and a vehicle electronic control unit. The at least two lamps are provided in the vehicle. The lamp electronic control unit is provided in each of the at least two lamps and configured to perform a lamp control on the each of the at least two lamps. The vehicle electronic control unit is provided in the vehicle and configured to communicate a control signal to the lamp electronic control unit. The vehicle electronic control unit is connected to the lamp electronic control unit via a first high-speed communications line. The lamp electronic control unit is configured to independently perform the lamp control by communication through the first high-speed communications line.

In the above aspect, the each of the at least two lamps may include a lamp unit on which a light distribution control is performable. The lamp electronic control unit may be connected to the lamp unit via a second high-speed communications line. The lamp electronic control unit may be configured to control the lamp unit by communication through the second high-speed communications line. Further, in the above configuration, the each of the at least two lamps may include an actuator configured to perform optical axis adjustment of the lamp unit. The lamp electronic control unit may be connected to the actuator via a second high-speed communications line. The lamp electronic control unit may be configured to control the actuator by communication through the second high-speed communications line.

In the above configuration, the lamp electronic control unit may include a first high-speed communications circuit portion configured to control the lamp unit, and a second high-speed communications circuit portion configured to control the actuator. Further, in the above configuration, the first high-speed communications circuit portion and the second high-speed communications circuit portion may be constituted by one high-speed communications circuit portion. Further, in the above configuration, the first high-speed communications line and the second high-speed communications line may be CAN communications lines. Further, in the above configuration, the at least two lamps may be right and left head lamps of the vehicle. The lamp electronic control unit may be configured to perform a light distribution control and an optical axis control on a corresponding one of the head lamps. Further, in the above configuration, the lamp unit may be a lamp unit on which an ADB light distribution control is performable. Further, in the above configuration, the actuator may be a leveling actuator configured to control an optical axis of the lamp unit in the up-down direction. Further, in the above configuration, the lamp electronic control unit may be configured to independently control the leveling actuator by following changes in a roll angle of the vehicle.

In the above aspect, the vehicle ECU is connected to the lamp ECU via the first high-speed communications line, and the lamp ECU can independently perform a lamp control by communication through the first high-speed communications line. Accordingly, even when an abnormality occurs in one of the lamps, the lamp ECU of the other one of the lamps can keep performing control based on a control signal communicated at high speed from the vehicle ECU through the first high-speed communications line. Here, a fail-safe is secured, and a high-speed and high-definition lamp control can be achieved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an automobile in which a lamp control device of the present disclosure is applied to head lamps;

FIG. 2 is a cut-way front view of part of a right head lamp;

FIG. 3 is an enlarged sectional view taken along a line III-III in FIG. 2;

FIG. 4A is a light distribution diagram of a low-beam light distribution and an ADB light distribution;

FIG. 4B is a light distribution diagram of a low-beam light distribution and an ADB light distribution;

FIG. 5 is a block configuration diagram of a lamp control device according to Embodiment 1;

FIG. 6 is a block configuration diagram of a lamp control device according to Embodiment 2;

FIG. 7A is a schematic view to describe a leveling control;

FIG. 7B is a schematic view to describe the leveling control; and

FIG. 8 is a block configuration diagram of a lamp control device according to Embodiment 3.

### DETAILED DESCRIPTION OF EMBODIMENTS

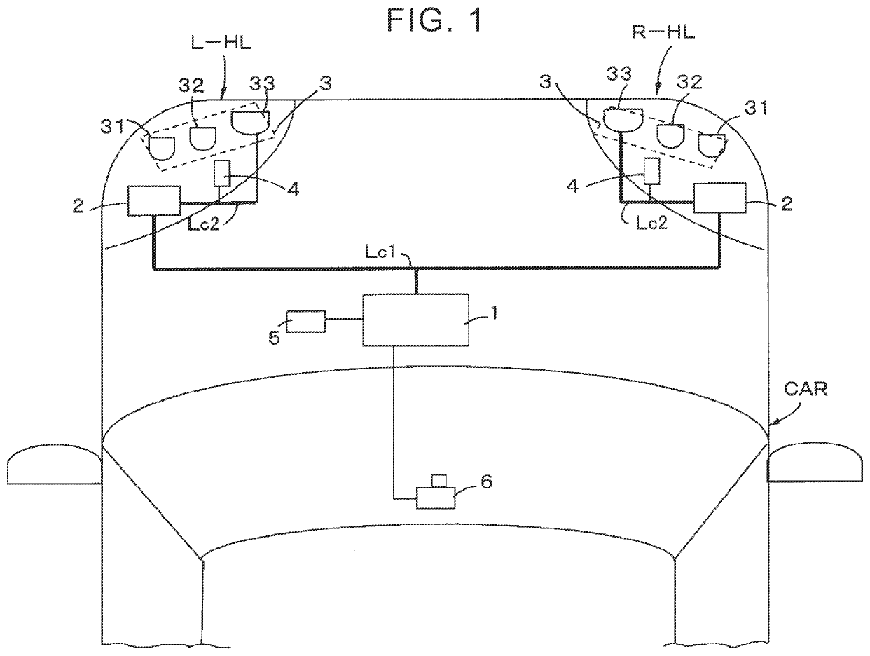

Next will be described embodiments of the present disclosure with reference to the drawings. FIG. 1 is a conceptual configuration diagram of an embodiment in which the present disclosure is applied to a lamp control device configured to control right and left head lamps of an automobile. Right and left head lamps R-HL, L-HL disposed in a vehicle-body front portion of an automobile CAR are each provided with a composite lamp unit 3 and a leveling actuator 4 and each further provided with a lamp ECU 2 configured to control the composite lamp unit 3 and the leveling actuator 4. The lamp ECU 2 corresponds to a lamp control unit in the present disclosure.

Although details of the lamp ECU 2 will be described later, the right and left lamp ECUS 2 are each connected to a vehicle ECU 1 provided in the automobile CAR via a vehicle CAN line Lc1, so that the right and left lamp ECUS 2 communicate with the vehicle ECU 1 via predetermined control signals so as to control respective lamp units 3 and respective leveling actuators 4. The vehicle ECU 1 can perform a lamp control and also perform various controls including an engine control in the automobile CAR, and the vehicle ECU 1 corresponds to a vehicle control unit in the present disclosure. The vehicle CAN line Lc1 is a first high-speed communications line through which the vehicle ECU 1 is connected to each of the right and left lamp ECUS 2 by high-speed communication via CAN signals in order to perform these controls.

Further, a sensor group 5 configured to acquire information for the controls is connected to the vehicle ECU 1. The sensor group 5 is constituted by a plurality of sensors. Specific descriptions of the sensors are omitted, but as sensors related to the present disclosure, the sensor group 5 is constituted by a vehicle speed sensor configured to detect a vehicle speed of the automobile, an acceleration sensor configured to detect an acceleration of the automobile, and a steering angle sensor configured to detect a steering angle of the automobile. Further, a camera 6 as an imaging unit used for an ADB light distribution control is connected to the vehicle ECU 1.

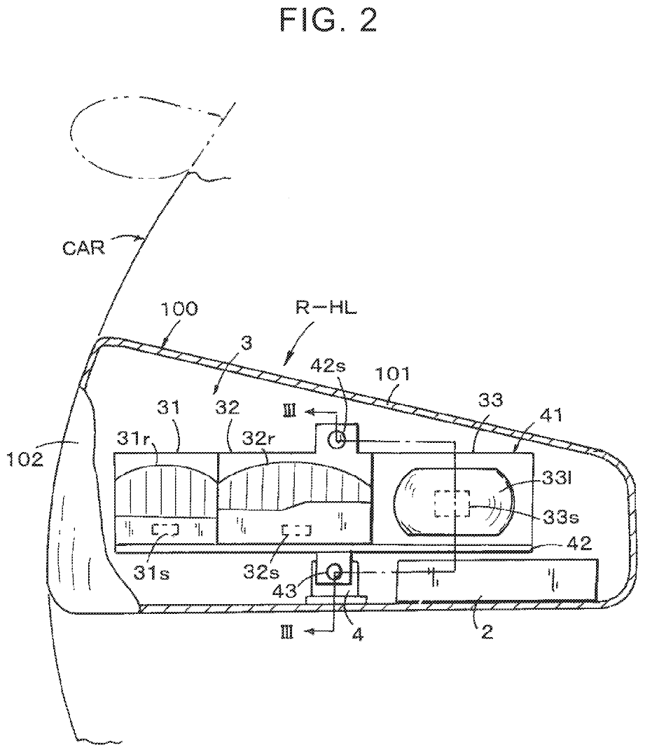

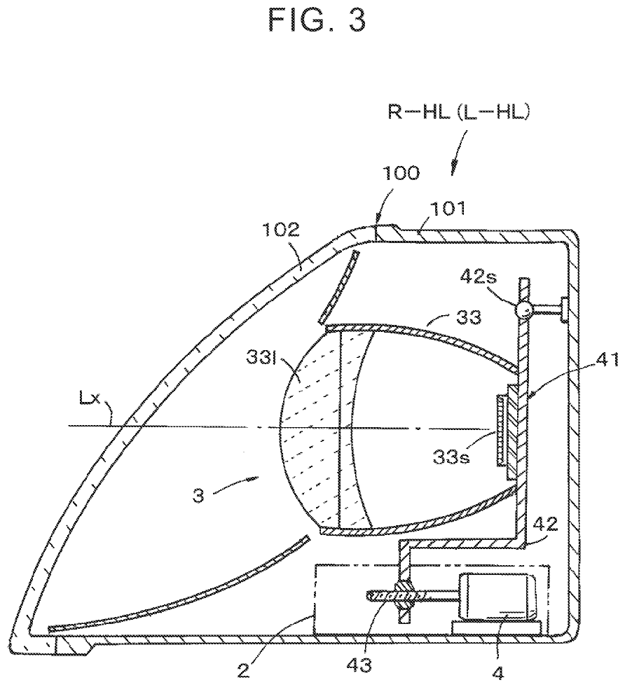

The right and left head lamps R-HL, L-HL are configured symmetrically. FIG. 2 is a cut-way front view of part of the right head lamp R-HL, and FIG. 3 is an enlarged sectional view taken along a line III-III in FIG. 2. In these figures, the right head lamp R-HL includes a lamp housing 100 attached to a vehicle body of the automobile. The composite lamp unit 3 and the leveling actuator 4 are disposed inside the lamp housing 100, and the lamp ECU 2 for controlling them is also internally mounted in the lamp housing 100. The lamp housing 100 is constituted by a container-shaped lamp body 101 the front side of which is opened, and a translucent cover 102 attached to a front face opening of the lamp body 101.

The composite lamp unit 3 is constituted by a plurality of lamp units, i.e., a clearance lamp unit (CLL) 31, a low-beam lamp unit (LoL) 32, and an ADB lamp unit (ADBL) 33 herein, and the lamp units 31 to 33 are assembled integrally. The clearance lamp unit 31 and the low-beam lamp unit 32 are configured as general reflector lamps. Although detailed descriptions of the clearance lamp unit 31 and the low-beam lamp unit 32 are omitted herein, the clearance lamp unit 31 and the low-beam lamp unit 32 are configured to irradiate predetermined light distribution regions with light emitted from respective light sources 31s, 32s by means of reflectors 31r, 32r. The light sources 31s, 32s are each constituted by an LED. The clearance lamp unit 31 may be provided as a daytime driving lamp unit.

The ADB lamp unit 33 is configured as a projector lamp, and a schematic sectional structure of the ADB lamp unit 33 is illustrated in FIG. 3. The ADB lamp unit 33 includes a light source 33s and a projection lens 331 configured to project light emitted from the light source 33s. The ADB lamp unit 33 can control a light pattern formed on a light-emitting surface by controlling light emission from the light source 33s. By projecting the light pattern thus formed to a front region ahead of the automobile by the projection lens 331, the front region can be irradiated with light by a desired light distribution.

Although the light source 33s is not specifically illustrated herein, the light source 33s is constituted by a multi-split light emitter (a multi-split LED array) in which several thousands of microscopic LEDS in μm-order are arranged in a matrix form. When the lamp ECU 2 performs a light emission control, multiple microscopic LEDS selectively emit light. By the selective light emission from the microscopic LEDS, a desired light pattern is formed on the light-emitting surface of the light source 33s, and the light pattern is projected by the projection lens 331. Hereby, microscopic irradiation regions ahead of the automobile and corresponding to the microscopic LEDS emitting light are irradiated with light, and thus, an ADB light distribution control is performed.

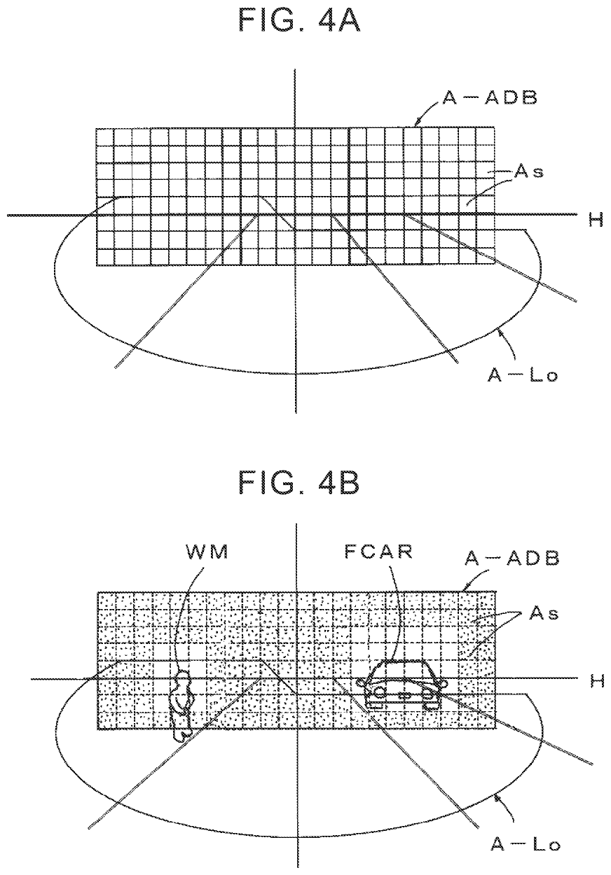

FIG. 4A is a view to describe light distribution patterns of the low-beam lamp unit 32 and the ADB lamp unit 33. The low-beam lamp unit 32 irradiates a low-beam light distribution region A-Lo with light. The low-beam light distribution region A-Lo has a predetermined cut-off line along a horizontal line H. The ADB lamp unit 33 irradiates an ADB light distribution region A-ADB with light. The ADB light distribution region A-ADB includes the cut-off line and is place above the cut-off line. The ADB light distribution region A-ADB is a region in which microscopic irradiation regions As are arranged in a grid pattern. The microscopic irradiation regions As correspond to the microscopic LEDS of the multi-split LED array constituting the light source 33s. The ADB light distribution region A-ADB is formed such that the microscopic irradiation regions As irradiated with light from the microscopic LEDS emitting light are assembled.

The ADB lamp unit 33 controls light emission per unit including one or more microscopic LEDS constituting the multi-split LED array of the light source 33s (this unit will be also referred to as a channel). Hereby, the ADB lamp unit 33 can perform light irradiation per unit, that is, per one or more microscopic irradiation regions As. Hereby, an ADB light distribution control with a desired light distribution pattern constituted by the microscopic irradiation regions As corresponding to the microscopic LEDS emitting light is performed. The number of channels can be set to dozens to several hundreds, for example.

In the meantime, as illustrated in FIGS. 2, 3, the leveling actuator 4 is configured as a driving portion for a leveling mechanism 41 disposed inside the lamp housing 100. The leveling mechanism 41 includes a leveling frame 42 tiltable in the front-rear direction of the head lamp. The leveling frame 42 is supported by the lamp body 101 via a supporting point 42s provided in an upper part of the leveling frame 42, and a lower part of the leveling frame 42 is connected to the leveling actuator 4. The leveling actuator 4 includes a drive screw 43 driven to be axially rotated by a motor as a drive source, for example, and the drive screw 43 is threadedly engaged to the leveling frame 42.

When the leveling actuator 4 is driven, the drive screw 43 is axially rotated, so that the lower part of the leveling frame 42 threadedly engaged with the drive screw 43 is moved forward or backward such that the leveling frame 42 is tilted around the supporting point 42s. The composite lamp unit 3, that is, three lamp units 31 to 33 are mounted on the leveling frame 42. The composite lamp unit 3 is tilted together with the leveling frame 42 by driving of the leveling actuator 4, so that each of the lamp units 31 to 33 is controlled such that its optical axis Lx is changed in the up-down direction. Thus, a leveling control is performed.

The lamp ECU 2 is electrically connected to the composite lamp unit 3 and the leveling actuator 4 and controls turning on and off and light distribution in the composite lamp unit 3. Further, the lamp ECU 2 performs the leveling control on the composite lamp unit 3 by the leveling actuator 4. The controls on the composite lamp unit 3 and the leveling actuator 4 by the lamp ECU 2 are collectively referred to as a lamp control, and a lamp control device including the lamp ECU 2 is configured as Embodiments 1 to 3 as follows, for example.

### Embodiment 1

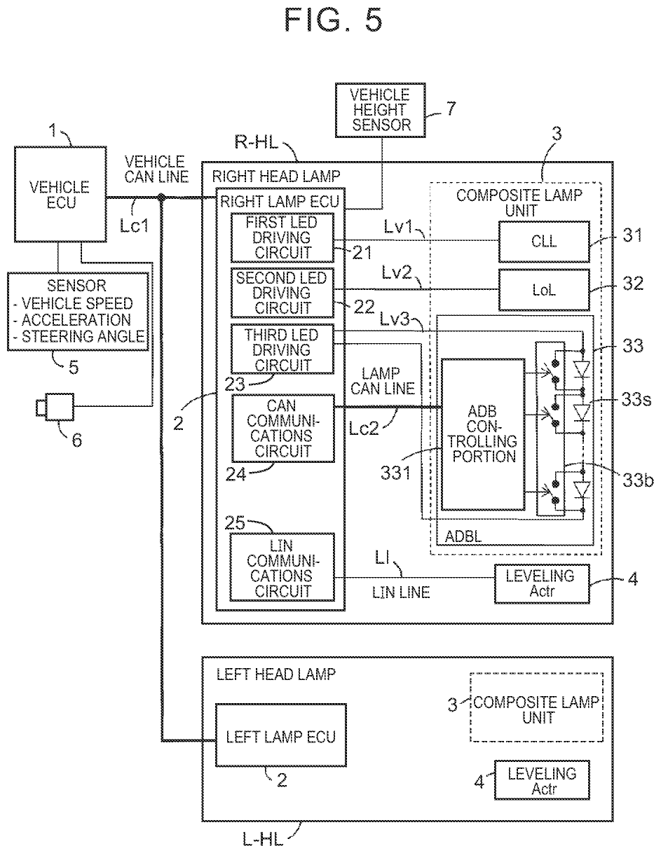

FIG. 5 is a block configuration diagram of an electrical system of a lamp control device according to Embodiment 1. Here, a configuration of the right head lamp R-HL is illustrated in detail, but the left head lamp L-HL is partially illustrated in a simplified manner. In the right head lamp R-HL, the lamp ECU 2 includes first to third LED driving circuit portions 21, 22, 23. The first LED driving circuit portion 21 is connected to the clearance lamp unit 31 via a first line (CL line) Lv1 of a voltage level and supplies a current for light emission to the LED as the light source 31s. The second LED driving circuit portion 22 is connected to the low-beam lamp unit 32 via a second line (Lo line) Lv2 of a voltage level similarly to the above and supplies a current for light emission to the LED as the light source 32s. The third LED driving circuit portion 23 is connected to the ADB lamp unit 33 via a third line (ADB line) Lv3 of a voltage level and supplies a current for light emission to the multi-split LEDS as the light source 33s.

Further, the lamp ECU 2 includes a CAN communications circuit portion 24 as a high-speed communications circuit portion. The CAN communications circuit portion 24 is connected to the ADB lamp unit 33 via a lamp CAN line Lc2. The lamp CAN line Lc2 constitutes a second high-speed communications line in the present disclosure. The CAN communications circuit portion 24 has a function to process a control signal transmitted through the vehicle CAN line Lc1 connected to the vehicle ECU 1 as described above such that the control signal is processed at high speed corresponding to a communication speed of the control signal. Further, the CAN communications circuit portion 24 is configured to control the ADB lamp unit 33 based on the signal thus processed.

As described above, the ADB lamp unit 33 is configured to perform a light-emission control per channel unit on the microscopic LEDS of the multi-split LED array as the light source 33s and is provided with an ADB controlling portion 331 for the light-emission control. As schematically illustrated in FIG. 5, the ADB controlling portion 331 has a function to selectively perform an on-off control on a plurality of bypass switches 33b provided such that the bypass switches 33b are each connected in parallel to one or more microscopic LEDS as a channel unit in the light source 33s. The ADB controlling portion 331 is controlled by the CAN communications circuit portion 24 connected via the lamp CAN line Lc2 such that a microscopic LED (33s) connected in parallel to the bypass switch 33b that is turned off emits light, and a microscopic LED (33s) connected in parallel to the bypass switch 33b that is turned on stops light emission.

Accordingly, in the lamp ECU 2, signal processing in the CAN communications circuit portion 24 is performed on a signal communicated at high speed from the vehicle ECU 1 through the vehicle CAN line Lc1, and further, the processed signal is transmitted to the ADB controlling portion 331 through the lamp CAN line Lc2, so that the bypass switches 33b are controlled at high speed. Hereby, selective light emission from the microscopic LEDS in the multi-split LED array constituting the light source 33s is controlled, so that an ADB control on the ADB lamp unit 33 is performed.

Further, as illustrated in FIG. 5, the lamp ECU 2 includes a LIN communications circuit portion 25 as a low-speed communications circuit portion the communication speed of which is lower than that of the CAN communications circuit portion 24. The LIN communications circuit portion 25 is connected to the leveling actuator 4 via a LIN line L1 as a low-speed communications line in the present disclosure. The LIN communications circuit portion 25 is configured to process a signal transmitted from the vehicle ECU 1 through the vehicle CAN line Lc1, for example, into a signal at a communication speed suitable for the specification of the leveling actuator 4 and to control the leveling actuator 4 based on the signal.

Note that, in Embodiment 1, a vehicle height sensor 7 is connected to the lamp ECU 2. A vehicle height detected by the vehicle height sensor 7 is input into the LIN communications circuit portion 25, and the LIN communications circuit portion 25 is configured to calculate a pitch angle of the automobile (an inclination angle of the vehicle body of the automobile in the front-rear direction) based on the vehicle height and to control the leveling actuator 4 through the LIN line L1 based on the pitch angle thus calculated.

The left head lamp L-HL has the same configuration as above and includes the lamp ECU 2, the composite lamp unit 3, and the leveling actuator 4 that are illustrated in a simplified manner. In Embodiment 1, the vehicle height sensor 7 is not connected to the lamp ECU 2 of the left head lamp L-HL. In the meantime, the lamp ECU 2 of the left head lamp L-HL is connected to the LIN communications circuit portion 25 of the right head lamp R-HL via a LIN line L1.

In the head lamp configured as described above, when a lighting control signal from the vehicle ECU 1 is transmitted to each of the lamp ECUS 2 of the right and left head lamps by CAN communication through the vehicle CAN line Lc1, the first to third LED driving circuit portions 21 to 23 of the each of the lamp ECUS 2 supply predetermined currents to respective light sources, namely, respective LEDS of their corresponding lamp units 31 to 33. Hereby, the LEDS of the clearance lamp unit 31 and the low-beam lamp unit 32 emit light, so that a lamp lighting state is established. Further, in the ADB lamp unit 33, the multi-split LED array is brought into a light emission stand-by state.

In the stand-by state of the ADB lamp unit 33, when an ADB light distribution control signal from the vehicle ECU 1 is transmitted to each of the right and left lamp ECUS 2 by CAN communication through the vehicle CAN line Lc1, the CAN communications circuit portion 24 performs an ADB light distribution control by CAN communication through the lamp CAN line Lc2. For example, the vehicle ECU 1 acquires preceding vehicle information from an image of a front region ahead of the automobile, the image being captured by the camera 6. Subsequently, the CAN communications circuit portion 24 acquires the preceding vehicle information through the vehicle CAN line Lc1 and controls the ADB controlling portion based on the preceding vehicle information.

That is, the CAN communications circuit portion 24 controls the ADB controlling portion 331 by CAN communication through the lamp CAN line Lc2 such that the bypass switches 33b for microscopic LEDS corresponding to microscopic irradiation regions where a preceding vehicle is present is turned on, so that the microscopic LEDS stop light emission. The bypass switches 33b for other microscopic LEDS are turned off so that the other microscopic LEDS emit light. Hereby, as illustrated in FIG. 4B, an ADB light distribution control is performed such that regions where a preceding vehicle (oncoming vehicle) FCAR or a walker WM is present are not irradiated with light while ADB light distribution regions other than the above regions are irradiated with light. In FIG. 4B, regions with dots are irradiated with light.

In the ADB light distribution control, since there are a quite large number of microscopic LEDS constituting the multi-split LED array as the light source 33s, many channels of the microscopic irradiation regions as units for the ADB light distribution control can be set. Accordingly, by performing light irradiation per channel unit as such, a high-definition ADB light distribution control by which only regions with no preceding vehicle can be irradiated with light is achieved.

In the meantime, it is necessary to control such a large number of channels instantly, and an increase in speed of the ADB control is required. Particularly, an ADB light distribution control in which the microscopic irradiation regions are changed from one to another at high speed by following a change with time of a relative position of a preceding vehicle is required. An ADB light distribution control signal is transmitted from the vehicle ECU 1 to the CAN communications circuit portion 24 by CAN communication through the vehicle CAN line Lc1, and further, the CAN communications circuit portion 24 controls the ADB controlling portion 331 by CAN communication through the lamp CAN line Lc2. This enables a high-speed control in comparison with a conventional control by LIN communication through a LIN line, and it is possible to achieve a high-definition and high-speed ADB light distribution control required for the ADB lamp unit 33.

In the meantime, when a leveling control signal is transmitted from the vehicle ECU 1 to each of the lamp ECUS 2 of the right and left head lamps through the vehicle CAN line Lc1, the LIN communications circuit portion 25 calculates a pitch angle of the automobile (an inclination angle in the front-rear direction) based on a change in the vehicle height detected by the vehicle height sensor 7. Based on a leveling control signal obtained from the pitch angle, the leveling actuator 4 is controlled by LIN communication through the LIN line L1, thereby performing optical axis adjustment of the composite lamp unit 3. A control speed required for the leveling control is lower than that of the ADB light distribution control, and therefore, even by a control by LIN communication through the LIN line L1, the LIN communications circuit portion 25 can achieve a leveling control following a vehicle height change in a normal automobile.

The lamp control described above is performed similarly in both of the lamp ECUS 2 of the right and left head lamps R-HL, L-HL. Note that, the vehicle height sensor 7 is not connected to the lamp ECU 2 of the left head lamp L-HL. Accordingly, at the time of the leveling control, the left head lamp L-HL uses the pitch angle calculated by the lamp ECU 2 of the right head lamp R-HL. That is, the pitch angle is transmitted to the lamp ECU 2 of the left head lamp L-HL through the LIN line L1 of the right head lamp R-HL. Accordingly, a leveling control having responsiveness equivalent to that in the right head lamp R-HL can be also achieved by the lamp ECU 2 of the left head lamp L-HL.

As such, the lamp ECU 2 of each of the right and left head lamps R-HL, L-HL is configured as an independent lamp ECU connected to the vehicle ECU 1 via the vehicle CAN line Lc1 and configured to perform control based on a signal transmitted by CAN communication. Accordingly, even when an abnormality occurs in the lamp ECU 2 of one of the head lamps, e.g., the left head lamp L-HL and the controls on the composite lamp unit 3 and the leveling actuator 4 in the left head lamp L-HL are stopped, the lamp ECU 2 of the right head lamp R-HL that is normal can perform a normal and high-speed control by CAN communication with the vehicle ECU 1 via the vehicle CAN line Lc1. In the meantime, when an abnormality occurs in the lamp ECU 2 of the right head lamp R-HL, the lamp ECU 2 of the left head lamp L-HL can perform a normal control. Accordingly, even when either one of the head lamps has an abnormality, the lamp control by the other one of the head lamps, particularly, the ADB light distribution control and the leveling control are secured, and thus, a fail-safe is secured.

Note that, when an abnormality occurs in the lamp ECU 2 of the right head lamp R-HL, an output from the vehicle height sensor 7 connected thereto may be transmitted to the lamp ECU 2 of the left head lamp L-HL by CAN communication via the vehicle CAN line Lc1. In this case, the lamp ECU 2 of the left head lamp L-HL performs the leveling control by calculating a pitch angle based on a detection output from the vehicle height sensor 7, the detection output being transmitted to the lamp ECU 2 of the left head lamp L-HL. A fail-safe is hereby secured in this point.

Incidentally, in a conventional master-slave mode, a vehicle CAN line is connected to a lamp ECU on a master side, a lamp ECU on a slave side is connected to the lamp ECU on the master side via a LIN line, and respective lamp units and respective actuators on the master side and on the slave side are controlled by LIN communication based on a control signal obtained in the lamp ECU on the master side. On this account, when an abnormality occurs on the master side, the controls on the lamp unit and the actuator on the slave side are stopped as well as the master side, and this is not preferable in terms of a fail-safe.

Further, in the conventional master-slave mode, respective lamp units and respective leveling actuators of lamps on the master side and the slave side are connected to the lamp ECU on the master side via the same LIN line, and the lamp units and the leveling actuators of the lamps on the master side and the slave side are controlled through this LIN line. On this account, it is necessary to set IDS to distinguish the lamp units and the leveling actuators of the lamps from each other at the time of controlling the lamp units and the leveling actuators of the lamps, so that the controls are complicated.

In Embodiment 1, as described above, even when one of the lamp ECUS 2 has an abnormality, the other one of the lamp ECUS 2 that is normal performs control independently. That is, at least either one of the right and left head lamps can be controlled normally, so that a fail-safe can be secured. Note that, in a case where a head lamp having an abnormality is turned off, it is also possible to control a normal head lamp such that the light amount of the normal head lamp is increased to secure the light amount of whole light irradiation of the head lamps. Further, the lamp ECUS 2 of the right and left head lamps perform respective controls independently. Accordingly, it is not necessary to set IDS to the lamp ECUS 2 so as to distinguish the lamp units and the leveling actuators from each other, so that the controls are not complicated.

### Embodiment 2

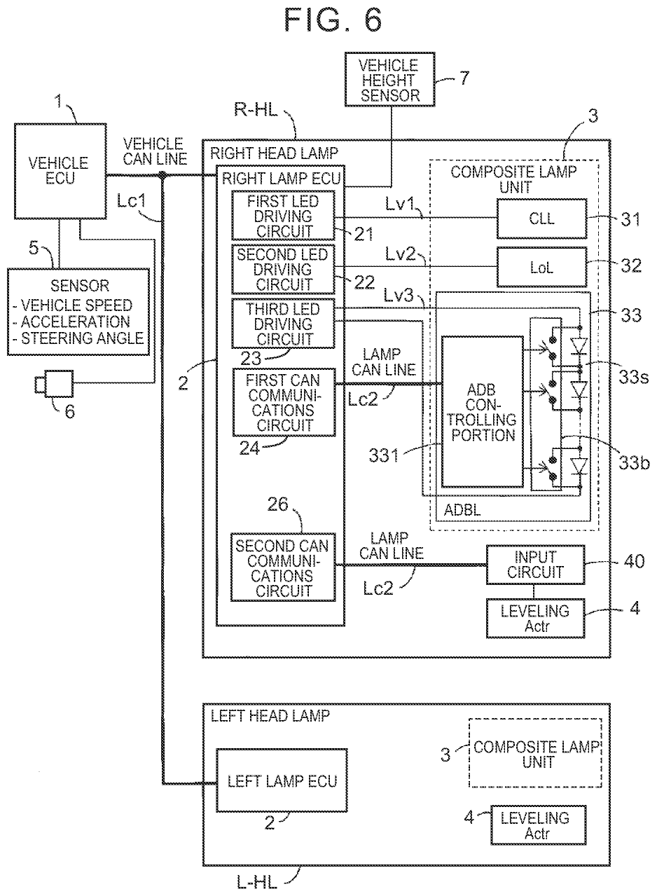

FIG. 6 is a block configuration diagram of an electrical system of a lamp control device according to Embodiment 2. A part equivalent to a part in Embodiment 1 has the same reference sign as that of the part in Embodiment 1, and a detailed description thereof is omitted. The right and left head lamps R-HL, L-HL have the same configuration and each include the composite lamp unit 3 and the leveling actuator 4 such that the composite lamp unit 3 and the leveling actuator 4 are controlled by their corresponding lamp ECU 2. This is the same as the configuration in Embodiment 1. Further, the lamp ECUS 2 of the right and left head lamps are connected to the vehicle ECU 1 via the vehicle CAN line Lc1, and this is also the same as the configuration in Embodiment 1.

Each of the lamp ECUS includes first to third LED driving circuit portions 21 to 23 and two CAN communications circuit portions 24, 26. Similarly to Embodiment 1, the first to third LED driving circuit portions 21 to 23 control currents to be supplied to the LEDS constituting respective light sources of the clearance lamp unit 31, the low-beam lamp unit 32, and the ADB lamp unit 33 constituting the composite lamp unit 3.

The first CAN communications circuit portion 24 provided in the lamp ECU 2 is connected to the ADB controlling portion 331 of the ADB lamp unit 33 via the lamp CAN line Lc2. Similarly to Embodiment 1, the first CAN communications circuit portion 24 performs an ADB light distribution control on the ADB lamp unit 33 by controlling the ADB controlling portion 331.

The second CAN communications circuit portion 26 is connected to the leveling actuator 4 via a different lamp CAN line Lc2, and the second CAN communications circuit portion 26 controls the leveling actuator 4 by CAN communication through the lamp CAN line Lc2. The lamp CAN line Lc2 constitutes the second high-speed communications line in the present disclosure, similarly to Embodiment 1.

In the lamp ECU of Embodiment 2, the second CAN communications circuit portion 26 is provided instead of the LIN communications circuit portion 25 of Embodiment 1, and the second CAN communications circuit portion 26 is configured to control the leveling actuator 4 by CAN communication. A conventional leveling actuator is controlled based on a voltage level or controlled by LIN communication. However, the leveling actuator 4 in Embodiment 2 is configured to be controllable based on a CAN signal through the lamp CAN line Lc2. Herein, the leveling actuator 4 includes an input circuit portion 40 configured to convert a signal of CAN communication into a signal of LIN communication or voltage level, in other words, the leveling actuator 4 includes an interface circuit portion.

In Embodiment 2, the first CAN communications circuit portion 24 performs an ADB light distribution control at high speed on the ADB lamp unit 33 by CAN communication through the lamp CAN line Lc2. At the same time, the second CAN communications circuit portion 26 can control the leveling actuator 4 at high speed through the lamp CAN line Lc2. That is, the second CAN communications circuit portion 26 performs a leveling control by transmitting a high-speed leveling control signal to the input circuit portion 40 by CAN communication through the lamp CAN line Lc2.

Hereby, the leveling control can be performed at higher speed than a case of LIN communication through the LIN line L1 in Embodiment 1, and hereby, the leveling control on the composite lamp unit 3 by the leveling actuator 4 can be performed at high speed as well as the ADB light distribution control performable at high speed. Further, the second CAN communications circuit portions 26 of the lamp ECUS 2 of the right and left head lamps can independently perform respective leveling controls on respective leveling actuators 4, and thus, a fail-safe can be secured.

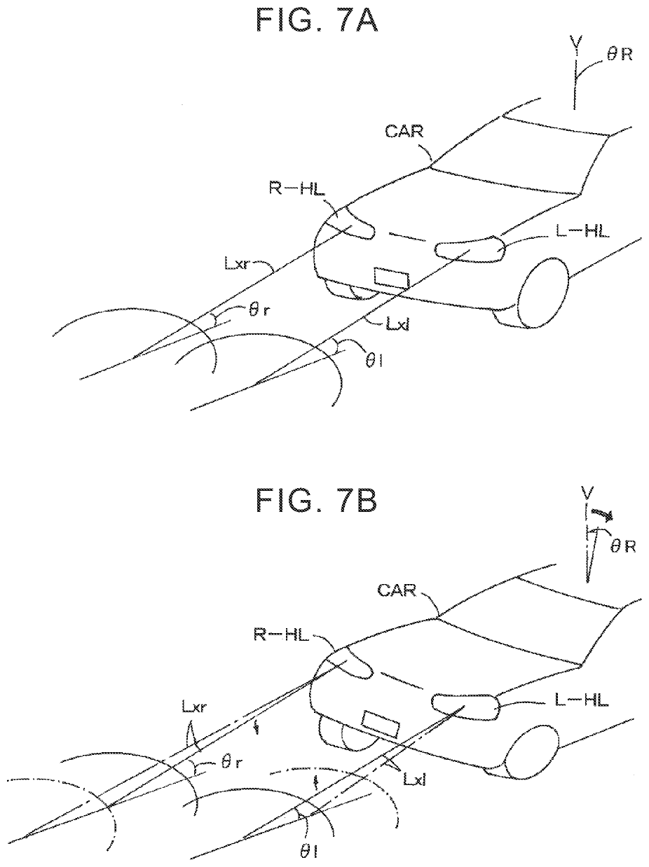

Thus, a high-speed leveling control by the leveling actuator 4 can be achieved. Accordingly, even when the vehicle body is rolled (inclined in the vehicle width direction) at the time when the automobile is turning, for example, a suitable leveling control can be achieved. As illustrated in FIG. 7A, when the automobile CAR does not roll, a roll angle (an inclination angle of the automobile CAR to a vertical line V) OR is 0, and respective leveling angles of the right and left head lamps R-HL, L-HL, that is, angles θr, θl of head-lamp optical axes Lxr, Lx1 to a road surface are the same.

In the meantime, when the automobile CAR is rolled so as to turn right or the like, e.g., when the automobile CAR is rolled to the left so that the roll angle θR >0 is established as illustrated in FIG. 7B, for example, respective vehicle heights of the right and left head lamps R-HL, L-HL become different from each other, so that the optic axial angles θr, θl of the head lamps differ from each other as indicated by chain lines. On this account, in order to perform suitable light irradiation to a front road surface region ahead of the automobile CAR, it is required to independently control respective leveling angles θr, θl of the right and left head lamps R-HL, L-HL. In this case, the leveling angle θr of the right head lamp R-HL the vehicle height of which is high is made smaller than the optical axis angle θl of the left head lamp L-HL.

At the time of this control, the second CAN communications circuit portions 26 of the right and left lamp ECUS 2 acquire detection signals of a vehicle speed, an acceleration, and a steering angle detected by the sensor group 5, i.e., the vehicle speed sensor, the acceleration sensor, and the steering angle sensor that are connected to the vehicle ECU 1 by CAN communication through the vehicle CAN line Lc1. Then, the roll angle θR of the automobile CAR is calculated by making a predetermined calculation based on these signals. This calculation is independently made by each of the right and left lamp ECUS 2, namely, each of the second CAN communications circuit portions 26. After that, each of the second CAN communications circuit portions 26 controls its corresponding leveling actuator 4 based on a control signal obtained from the roll angle thus calculated.

The control signal obtained in the second CAN communications circuit portion 26 is transmitted to the leveling actuator 4 by CAN communication through the lamp CAN line Lc2. In the leveling actuator 4, the input circuit portion 40 converts the signal of CAN communication into a signal of LIN communication or voltage level, so that the leveling actuator 4 is driven by the signal. Accordingly, the second CAN communications circuit portion 26 can control the leveling actuator 4 at high speed, thereby making it possible to achieve a highly responsive and reliable leveling control corresponding to high-speed fluctuations in the roll angle along with traveling of the automobile.

Note that, at the time of calculating the roll angle in the second CAN communications circuit portion 26, the second CAN communications circuit portion 26 may refer to the vehicle height detected by the vehicle height sensor 7. For example, the roll angle is calculated based on a difference in vehicle height between right and left front wheels or between right and left rear wheels. Alternatively, the roll angle may be calculated based on an output from a roll axis detection sensor constituted by the acceleration sensor.

In Embodiment 2, when the second CAN communications circuit portion 26 is configured to function as a LIN communications circuit portion, the second CAN communications circuit portion 26 can be configured as the LIN communications circuit portion 25 in Embodiment 1. With such a CAN communications circuit portion, the lamp ECU can be configured as a lamp ECU corresponding to both a leveling actuator for CAN communication and a leveling actuator for LIN communication or for voltage.

### Embodiment 3

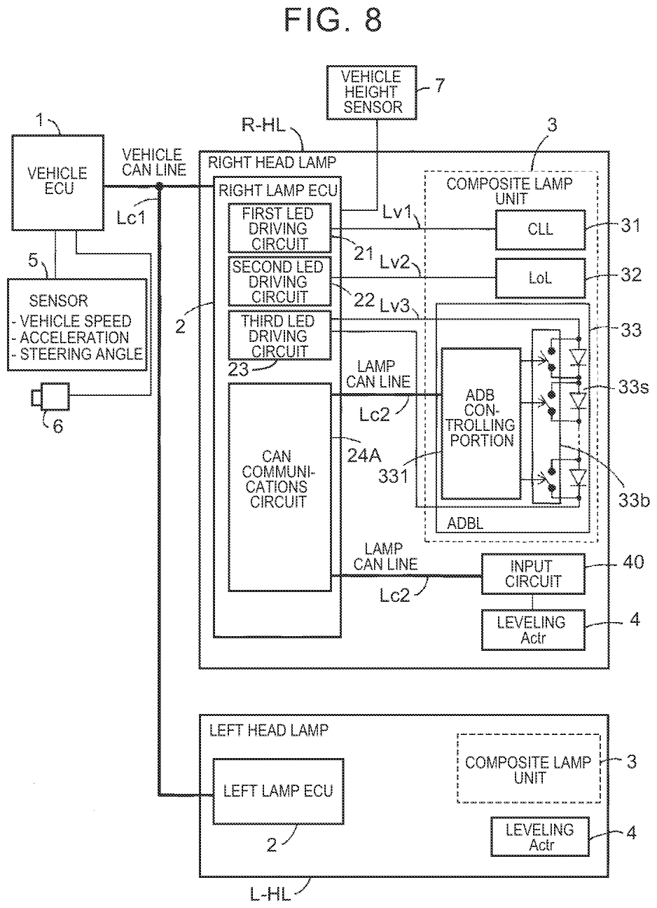

FIG. 8 is a block configuration diagram of an electrical system of a lamp control device according to Embodiment 3. A part equivalent to a part in Embodiment 2 has the same reference sign as that of the part in Embodiment 2, and a detailed description thereof is omitted. In Embodiment 3, an ADB light distribution control and a leveling control are performed by one CAN communications circuit portion 24A. That is, the CAN communications circuit portion 24A has both functions as the first CAN communications circuit portion 24 and the second CAN communications circuit portion 26 in Embodiment 2. The CAN communications circuit portion 24A is connected to the ADB lamp unit 33 and the leveling actuator 4 via respective lamp CAN lines Lc2.

In Embodiment 3, the CAN communications circuit portion 24A performs the ADB light distribution control and the leveling control in the ADB lamp unit 33. Further, these controls are performed by CAN communication through the lamp CAN lines Lc2, and therefore, high-speed controls can be achieved similarly to Embodiments 1, 2.

The head lamps according to Embodiments 1 to 3 described above deal with an example in which an ADB lamp unit using a multi-split LED array as a light source is employed as the ADB lamp unit 33. However, the ADB lamp unit 33 may be an ADB lamp unit constituted by a number of LEDS, an ADB lamp unit using a digital micromirror device (DMD), or a shade-switch ADB lamp unit. Further, the head lamp may include other lamp units instead of the low-beam lamp unit and the clearance lamp unit.

In Embodiments 1 to 3, the leveling actuator performs the leveling control by tilting the composite lamp unit. However, the leveling mechanism may be provided only for a given lamp unit among the lamp units so that the leveling control is performed only on the given lamp unit. Further, the leveling actuator may be driven by an electromagnetic solenoid as a drive source. Further, a swivel actuator configured to control the optical axis in the right-left direction may be provided in addition to or instead of the leveling actuator.

In the descriptions of the embodiments, a vehicle CAN line is employed as the high-speed communications line in the present disclosure, and a LIN line is employed as the low-speed communications line. However, these lines are not limited to lines called CAN or LIN and may be configured as a high-speed communications line and a low-speed communications line having communication speeds relatively different from each other.

A lamp targeted for the lamp control of the present disclosure is not limited to a head lamp, and the lamp control of the present disclosure is applicable to any lamp for a vehicle, provided that the lamp control is performable on a plurality of lamps included in the lamp.

What is claimed is:

1. A lamp control device for a vehicle, the lamp control device comprising:
at least two lamps provided in the vehicle;
a lamp electronic control unit provided in each of the at least two lamps and configured to perform a lamp control on the each of the at least two lamps; and
a vehicle electronic control unit provided in the vehicle and configured to communicate a control signal to the lamp electronic control unit, wherein:
the vehicle electronic control unit is connected to the lamp electronic control unit via a first high-speed communications line; and
the lamp electronic control unit is configured to independently perform the lamp control by communication through the first high-speed communications line.

2. The lamp control device according to claim 1, wherein:
the each of the at least two lamps includes a lamp unit on which a light distribution control is performable;
the lamp electronic control unit is connected to the lamp unit via a second high-speed communications line; and
the lamp electronic control unit is configured to control the lamp unit by communication through the second high-speed communications line.

3. The lamp control device according to claim 1, wherein:
the each of the at least two lamps includes an actuator configured to perform optical axis adjustment of the lamp unit;
the lamp electronic control unit is connected to the actuator via a second high-speed communications line; and
the lamp electronic control unit is configured to control the actuator by communication through the second high-speed communications line.

4. The lamp control device according to claim 3, wherein the lamp electronic control unit includes
a first high-speed communications circuit portion configured to control the lamp unit, and
a second high-speed communications circuit portion configured to control the actuator.

5. The lamp control device according to claim 4, wherein the first high-speed communications circuit portion and the second high-speed communications circuit portion are constituted by one high-speed communications circuit portion.

6. The lamp control device according to claim 2, wherein the first high-speed communications line and the second high-speed communications line are CAN communications lines.

7. The lamp control device according to claim 1, wherein:
the at least two lamps are right and left head lamps of the vehicle; and
the lamp electronic control unit is configured to perform a light distribution control and an optical axis control on a corresponding one of the head lamps.

8. The lamp control device according to claim 2, wherein the lamp unit is a lamp unit on which an ADB light distribution control is performable.

9. The lamp control device according to claim 3, wherein the actuator is a leveling actuator configured to control an optical axis of the lamp unit in an up-down direction.

10. The lamp control device according to claim 9, wherein the lamp electronic control unit is configured to independently control the leveling actuator by following changes in a roll angle of the vehicle.
